(19) United States
(12) Patent Application Publication
(10) Pub. No.: US 2009/0173722 A1
(43) Pub. Date: Jul. 9, 2009

(54) Method of Joining an Outer Sheet and an Inner Sheet, in Particular of an Attachment Part of a Motor Vehicle Body

(75) Inventors: Peter Cornelius, Kasel (DE); Axel Luft, Gusterath (DE); Mirko Weiland, Lockweiler (DE)

Correspondence Address: PROSKAUER ROSE LLP, ONE INTERNATIONAL PLACE, BOSTON, MA, 02110, US

(73) Assignee: ThyssenKrupp Drauz Nothelfer GmbH, Heilbronn (DE)

(21) Appl. No.: 12/299,415

(22) PCT Filed: May 2, 2007
(86) PCT No.: PCT/EP07/54268

§ 371 Date: Mar. 10, 2009

(30) Foreign Application Priority Data
May 5, 2006 (DE) 10 2006 020 920.6
Aug. 31, 2006 (DE) 10 2006 040 902.7

(51) Int. Cl. B23K 26/00

(52) U.S. Cl. 219/121.64; 219/121.63

(57) ABSTRACT

A method provides for joining an outer sheet and an inner sheet, in particular of an attachment part of a motor vehicle body. On the visible sides of an attachment part, a welding or brazing seam is produced between a fold of an outer sheet and an inner sheet. The outer sheet is held in a bed, and the inner sheet is pressed against the fold on an inner side thus forming a joining groove. To ensure that during beam welding or beam grazing the inner sheet is held in position on the fold, it is prevented from moving away without clamping by stops on an outer side. These stops are disposed in a row along the welding or brazing seam and in dependence upon the progress of the joining procedure can be moved individually out of a path of a welding or brazing head.

### CROSS-REFERENCE TO RELATED APPLICATIONS

This application is a National Phase Application of International Application No. PCT/EP2007/054268, filed on May 2, 2007, which claims the benefit of and priority to German Patent Application No. DE 10 2006 020 920.6, filed on May 5, 2006, and to German Patent Application No. DE 10 2006 040 902.7, filed on Aug. 31, 2006. The disclosures of the above applications are incorporated herein by reference in their entirety.

### FIELD OF THE INVENTION

The invention relates to a method of joining an outer sheet and an inner sheet, for example of an attachment part of a motor vehicle body, in which the outer sheet comprises, at least on a partial section of its circumferential edge, a fold which is directed towards the inner sheet. The inner sheet is pressed with its edge against it on an inner side thus forming a joining groove (i.e. joining seam, joining gap), and is joined to the fold by beam welding or beam brazing using a welding or brazing head.

### BACKGROUND OF THE INVENTION

In a known method (DE 103 17 552 B3), the joined partial section lies with the fold of the outer sheet against the visible side of the attachment part, which in a motor vehicle door is the side opposite to the hinge-side of the door and the side allocated to the sill, whereas in the other region not visible from the outside the edges of the outer sheet and the inner sheet are joined in such a manner as to overlap with each other. In this method, the outer and inner sheets are clamped only in the region of the mutually overlapping edges. It has been shown in practice that this type of joining method leads to problems in the partial section of the circumferential edge, where the fold is provided. During beam welding or beam brazing, the edge region of the inner sheet, which is typically held by elastic suction cups, is displaced outwardly by distortion due to heat introduced into the sheets. It is not possible using this method to join the inner and outer sheets in a process-reliable manner without any flaws on the visible side of the attachment part.

### SUMMARY OF THE INVENTION

In one aspect, the present invention provides a method of joining an outer sheet and an inner sheet, to produce a flawless joining seam.

In one embodiment, the inner sheet is held without clamping on its outer side over the outer sheet, which is fixed in a bed by hold-down devices, and is prevented from moving away from the outer sheet during the joining process by stops positioned on the outer side of the inner sheet (i.e. single-sided stops) in a row along the joining groove.

Embodiments in accordance with the invention dispense with any clamping of the inner sheet in the partial section having the fold. Nonetheless, it is still possible to produce a precisely positioned, flawless joining seam in a process-reliable manner due to the single-sided stops on the outer side of the inner sheet, because the inner sheet will tend primarily to move away from the outer sheet by reason of the radiation heat introduced.

In another embodiment, to improve the process reliability during the joining process so that the inner sheet is positioned even more precisely directly at the joining site, the inner sheet is held during the joining process by releasable holders which are disposed in a row along the joining groove and in proximity thereto and act upon the outer side of the inner sheet. These releasable holders also prevent any movement of the inner sheet in the direction of the outer sheet, which movement is, if any, small in comparison to the described tendency of the inner sheet to move away from the outer sheet.

In another embodiment, the joining procedure can be performed with the welding or brazing head located at intervals between the stops and hold-down devices. In a further embodiment, it is also possible to achieve a continuous joining seam, with hold-down devices and stops positioned close to the joining site, by individually adjustable stops and/or hold-down devices which are positioned in a row along the joining groove, if the stops and/or hold-down devices located in the path of the welding or brazing head clear the path for the welding or brazing head consecutively according to the progress of the joining procedure. In a corresponding manner, the releasable holders holding the inner sheet should also clear the path for the welding and brazing head.

As is known per se from the prior art, the edge of the inner sheet can be configured differently. In preferred embodiments in accordance with the present invention, the inner sheet is folded inwardly in a similar manner to the outer sheet. In general a welding material or filler is used, which can be introduced particularly effectively into the joining groove, even if the inner sheet is folded inwardly in the region of the joining section.

In some embodiments, the inner sheet is held on resilient suction cups. In other embodiments, the inner sheet is supported only or additionally on spacer elements which are provided between the inner sheet and the outer sheet. Suitable spacer elements are beads in the inner sheet or insert bodies between the inner sheet and the outer sheet. In some embodiments, spacer elements are not required in particular if using releasable holders to hold the inner sheet.

The outer sheet which is fixed in a bed can be fixed in various ways to the hold-down devices. In preferred embodiments, the hold-down devices press onto the edge of the fold so that the outer sheet is aligned with positional precision at the joining site.

Another aspect of the present invention relates to a device for joining an outer sheet and an inner sheet, wherein holding and fixing means are provided for the outer sheet and for the inner sheet. The inner sheet is held at a spaced interval above it and with its edge on the inner side in abutment against the folded edge of the outer sheet. Hold-down devices which press onto the edge of the outer sheet are also provided on the side of the inner sheet remote from the outer sheet along the joining groove, which is formed by the folded edge of the outer sheet and the edge of the inner sheet abutting against the folded edge, and stops are provided for the edge of the inner sheet and a movable welding and brazing head is provided along the joining groove.

In preferred embodiments, the stops are supported by pivotable blocks.

In a further embodiment in accordance with the invention, a hold-down device and a stop are each supported by a common block which according to the progress of the joining procedure can be adjusted from its operative position on the attachment part into a parked position which clears the movement path for the welding or brazing head.

In various embodiments, holders for the inner sheet can be mechanical, pneumatic or electromagnetic. Each holder which acts externally on the inner sheet can be activated in relation to its holding function, so that according to the progress of the joining procedure, each holder can be adjusted from its operative position on the inner sheet to a parked position which clears the movement path for the welding and brazing head. In particular, each holder can be supported by the pivotable, common block for one of the stops and one of the hold-down devices.

Since it is important in beam welding and/or beam brazing, in particular with a laser beam, that the beam is directed exactly onto the joining groove, in various embodiments the welding or brazing head can be controlled. If the welding filler material, e.g. brazing or welding wire, is used, it can be used as a gauge for the position of the joining groove. The welding or brazing head is then adjusted in dependence upon this gauging result. Therefore, the wire is used simultaneously as a “seam-finding sensor”.

### BRIEF DESCRIPTION OF THE DRAWINGS

The invention will be explained in detail hereinunder with reference to a drawing illustrating an exemplified embodiment. In detail in the drawing,

FIG. 1 shows a detail and a view of an attachment part as a door of a motor vehicle,

FIG. 2 shows a device for joining an outer sheet and an inner sheet of the attachment part of a motor vehicle body as shown in FIG. 1 in a schematic illustration and in a vertical cross-section in the operative position and, in dashed lines, the parked position,

FIG. 3 shows the device as shown in FIG. 2 in a view from the direction of the arrow P of FIG. 2,

FIG. 4 shows the device as shown in FIG. 2 in an enlarged section with a pivotable block with a stop and hold-down device, and in particular

FIGS. 4a-4c show a detail and cross-sectional view of an inner sheet and an outer sheet of the attachment part as shown in FIG. 1 with and without spacer elements in the intermediate space.

### DESCRIPTION

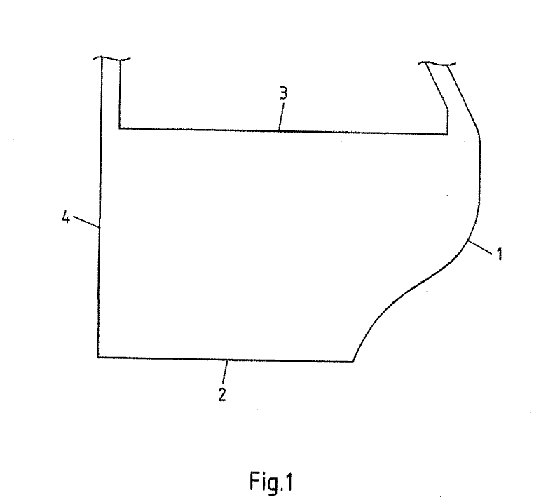

In an attachment part of a motor vehicle shown in FIG. 1, in particular a rear door, the method in accordance with the invention can be performed on the visible sides of the door, i.e. the rear side 1, the lock-side and the lower side 2 on the sill, whereas the side 3 on the window and the side 4 on the hinges can be joined according to conventional methods, in particular in a lap joint, as disclosed in DE 103 17 552 B3.

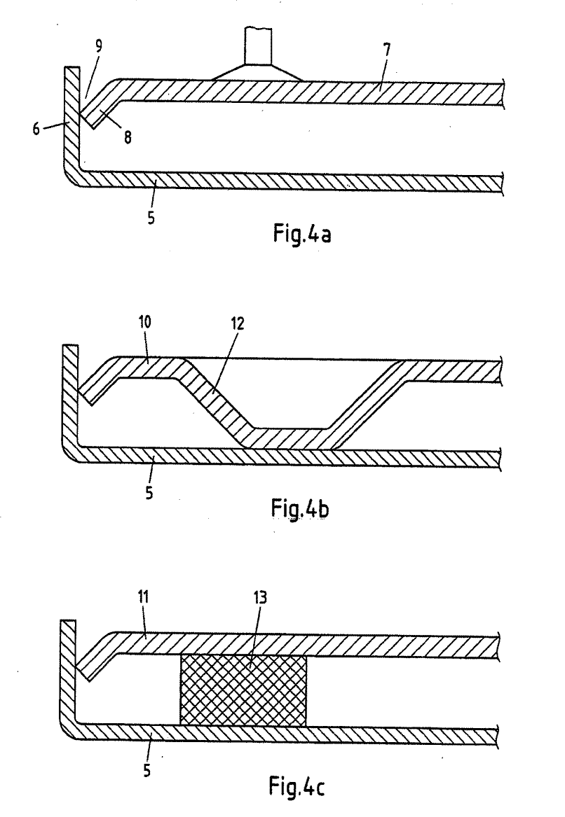

In order to prepare an outer sheet 5 for the join, it comprises on its visible sides 1, 2 a fold 6, as illustrated in FIG. 4a. The inner sheet 7 preferably also acquires a fold 8 which, however, is angled to a lesser extent than the fold 6. The inner sheet 7 is pushed on the inner side against the fold 6, so as to form a joining gap 9. Another two exemplified embodiments 4b, 4c differ from those in FIG. 4a merely in that between the outer sheet 5 and the inner sheet 10, 11 there is provided a spacer element in the form of a bead 12 or a body 13 which can preferably be foamed e.g. by thermal action.

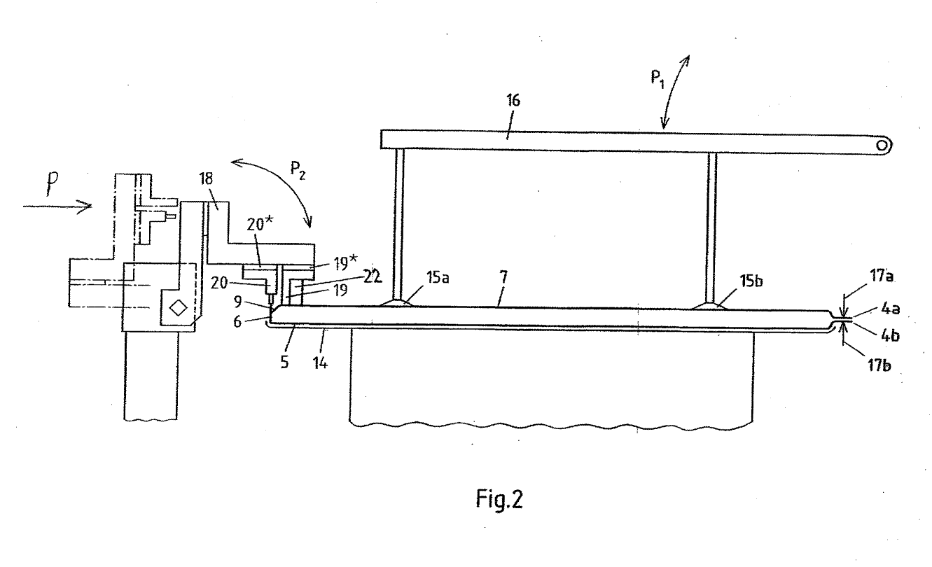

In order to be able to perform the joining procedure, the prepared outer sheet 5 as shown in FIG. 2 is positioned in a bed 14 and is aligned and held therein by means, not illustrated. The inner sheet 7 is held in position above the outer sheet 5 and in abutment against the fold 6 on the outer side by suction cups 15a, 15b of a pivot arm 16 which can be pivoted in the direction of the arrow P₁. On the non-visible side 4, mutually overlapping edge regions 4a, 4b are pressed onto each other by clamping means 17a, 17b, in order to connect them together by welding.

In contrast, on the visible side 1 specific means act upon the fold 6 of the outer sheet 5 and upon the inner sheet 7. These specific means include a plurality of similar structural units which are positioned in a row along the joining gap 9. Each structural unit uses a block 18 which can be pivoted in the direction of the arrow P₂ to support a stop 19 and a hold-down device 20. The stop 19 is positioned in such a manner that the inner sheet 7 is held without any pressure in abutment against the stop 19. The stop 19 can be adjusted in height by insert sheets 19*. The hold-down device 20 which can likewise be adjusted in height by insert sheets 20* is supported in a resilient manner and presses onto the free end side of the fold 6.

In order to hold the not directly supported edge of the inner sheet 7 in a more precise manner, the pivotable block 18 not only supports the stop 19 but also an activatable holding element (i.e. holder) 22. The holding element 22 can be activated in its holding function, and can be purely mechanical, pneumatic or electromagnetic. It holds the inner sheet 7 in abutment against the stop 19 and therefore in a precise position directly at the joining site.

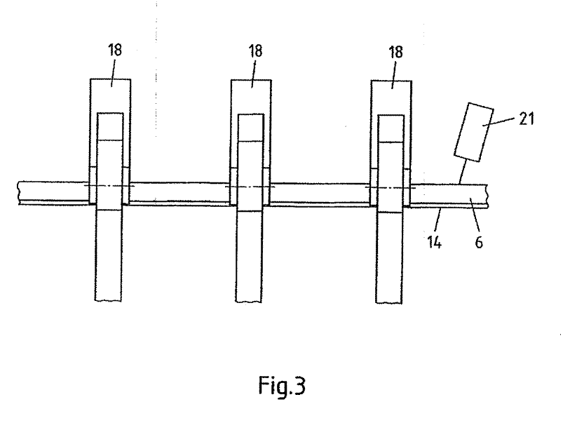

In order to carry out the joining procedure by beam welding or beam brazing, in particular using lasers, a welding or brazing head 21 (see FIG. 3) is provided which can be moved along the joining seam 9. The welding head 21 comprises a brazing/welding wire which gauges the joining groove 9 and in dependence upon the detected joining site transmits a signal for adjustment purposes to control means, not illustrated, of the welding or brazing head 21, so that the welding or brazing head 21 is always optimally aligned with respect to the joining groove 9. To ensure that the welding or brazing head 21 can be moved along the joining groove 9, the individual structural units with the stop 19 and the hold-down device 20 must clear the path. This occurs according to the progress of the joining procedure by pivoting the structural units 18, 19, 20 from their operative position, shown in FIG. 2, into the parked position illustrated by the dashed lines. Since the hold-down device 20 holds the outer sheet 5 in a fixed manner in the bed 14, and since the stop 19 in combination with the activatable holder 22 fixedly holds the inner sheet 7 relative thereto or prevents the inner sheet 7 from moving away, the radiation energy introduced during the joining process ensures that there is no relative displacement of the inner sheet 7 with respect to the fold 6 and that as a result the joining seam is clean.

1. Method of joining an outer sheet and an inner sheet,
wherein the outer sheet comprises, at least on a partial section of its circumferential edge, a fold which is directed towards the inner sheet and to which the inner sheet, which is pressed with an inner sheet edge against the outer sheet on the inner side of the outer sheet thus forming a joining groove, the fold and the inner sheet being joined by beam welding or beam brazing by welding or brazing head, and
wherein the inner sheet is held without clamping on an outer side of the inner sheet to the outer sheet which is fixed in a bed by hold-down devices, and is prevented from moving away from the outer sheet during a joining process by stops positioned on the outer side of the inner sheet.

2. Method as claimed in claim 1, wherein during the joining process the inner sheet is held by releasable holders which are disposed in a row along the joining groove and in proximity thereto and hold the outer side of the inner sheet.

3. Method as claimed in claim 1, wherein the stops clear a path for the welding or brazing head consecutively according to a progress of the joining procedure.

4. Method as claimed in claim 2, wherein the releasable holders clear a path for the welding or brazing head consecutively according to a progress of the joining procedure.

5. Method as claimed in any one of claim 1, wherein in a region of a joining section, the inner sheet is folded in a direction of the outer sheet.

6. Method as claimed in any one of claim 1, wherein the inner sheet is supported on the outer sheet by a spacer element which is disposed between the outer sheet and the inner sheet in a region of a joining section.

7. Method as claimed in claim 6, wherein the spacer element is a bead in the inner sheet or an insert body.

8. Method as claimed in claim 1, wherein pressure is applied by the hold-down devices onto an edge of the fold of the outer sheet.

9. Device for joining an outer sheet and an inner sheet of an attachment part, wherein
holders are provided for the outer sheet and for the inner sheet, the inner sheet being held at a spaced interval above the outer sheet and with an inner sheet edge on an inner side in abutment against a folded edge of the outer sheet,
hold-down devices which press onto the folded edge of the outer sheet are provided on a side of the inner sheet remote from the outer sheet along a joining groove which is formed by the folded edge of the outer sheet and the inner sheet edge abutting against the folded edge,
stops are provided for the inner sheet edge,
a welding or brazing head is provided which can be displaced along the joining groove.

10. Device in claim 9, wherein at least the stops are supported by pivotable blocks.

11. Device in claim 9, wherein at least one hold-down device and at least one stop are each supported by a common block which according to a progress of a joining procedure can be adjusted from an operative position on the attachment part into a parked position which clears a movement path for the welding or brazing head.

12. Device as claimed in claim 9, wherein a mechanical, pneumatic or electromagnetic holder which acts externally on the inner sheet can be activated in relation to holding function.

13. Device as claimed in claim 12, wherein according to a progress of a joining procedure, the mechanical, pneumatic, or electromagnetic holder can be adjusted from its operative position on the inner sheet into a parked position which clears a movement path for the welding or brazing head.

14. Device as claimed in claim 13, wherein each mechanical, pneumatic, or electromagnetic holder is supported by a pivotable, common block for one of the stops and one of the hold-down devices.
